(19) United States
(12) Patent Application Publication
(10) Pub. No.: US 2021/0256521 A1
(43) Pub. Date: Aug. 19, 2021

(54) FRAMEWORK FOR USING MACHINE-LEARNING MODELS TO IDENTIFY CARDHOLDERS TRAVELING ABROAD AND PREDICTING CARDHOLDER CROSS-BORDER CARD USAGE TO INCREASE PENETRATION OF CROSS-BORDER TRANSACTIONS

(71) Applicant: Visa International Service Association, San Francisco, CA (US)

(72) Inventors: Charles DING, San Carlos, CA (US); Ani YOU, Redwood City, CA (US)

(73) Assignee: Visa International Service Association, San Francisco, CA (US)

(21) Appl. No.: 16/790,630

(22) Filed: Feb. 13, 2020

(51) Int. Cl. G06Q 20/40; G06N 20/00; G06F 17/18; G06K 9/62

(52) U.S. Cl. CPC G06Q 20/4014; G06N 20/00; G06K 9/6256; G06K 9/6267; G06F 17/18

(57) ABSTRACT

A method comprises identifying, by a first machine-learning (ML) model, cardholders who have purchased an international travel reservation, the first ML model using as input payment transaction records and travel itinerary records retrieved from one or more databases. For each of the identified cardholders, the first ML model identifies a payment card used to purchase the international travel reservation, and a corresponding destination country and a departure date. A second ML model identifies the payment cards of the identified cardholders having low probability of being used for a cross-border transaction based at least in part on historical payment transactions. For the cardholders associated with low probability cross-border cards, an action is initiated, including providing an offer to the identified cardholders of the low probability cross-border cards, wherein the offer incentivizes use the low probability cross-border cards in the destination country prior to, or during, the international travel.

### BACKGROUND

Payment systems providers, including banks, networks and processors, generate revenue by providing access to payment systems for end parties, including consumers, merchants and enterprises. Processors and networks also generate money by providing payment services to intermediaries such as banks. In most payments systems (e.g., both open loop and closed loop), providers have a direct business relationship with end party customers. Providers set prices for the services, as do other businesses. Providers realize revenue from payments through direct and indirect sources. Direct revenue comes from fees explicitly charged to the end party, i.e. consumers and enterprises, and these may include transaction fees, interest on associated loans, monthly maintenance fees, and exception fees. Indirect revenue comes from the interest income on deposit balances, float and interchange.

Cross-border payments occur when an end party in one country pays an end party in another country. Both consumers and businesses use cards to make cross-border payments and the ability to provide the service to international travelers is one of the strengths of the card payments industry. Many payment systems providers handle cross-border payments by establishing private networks of banks, which have correspondent relationships which each other, to process and clear transactions. Payment systems providers may, over time, develop significant volumes and process these transactions internally, without relying on external banks or networks.

Payments systems operate on an in-country basis: only banks that are chartered or licensed to operate in a country may join a payments system in that country. Therefore, transferring money between countries often requires two separate transactions, one in the sending country and one and the receiving country. A single economic transaction in two separate payment systems creates complexity, and hefty fees are not uncommon. The management of foreign exchange creates an additional level of complexity, and is a source of considerable revenue to one or more parties to the transaction, including the payments systems provider.

Accordingly, it would be desirable to provide a framework for increasing penetration of cross-border transactions.

### BRIEF SUMMARY

The exemplary embodiment provides methods and systems for using machine-learning models to identify cardholders traveling abroad and predicting cardholder cross-border card usage to increase penetration of cross-border transactions. Aspects of exemplary embodiment include identifying, by a first machine-learning model executing on a computer, cardholders who have purchased an international travel reservation, the first machine-learning model using as input payment transaction records and travel itinerary records retrieved from one or more databases. For each of the identified cardholders, the first machine-learning model identifies a payment card used to purchase the international travel reservation, and a corresponding destination country and a departure date. A second machine-learning model executing on the computer identifies the payment cards of the identified cardholders having low probability of being used for a cross-border transaction based at least in part on historical payment transaction, the second machine-learning model using as input historical payment transactions. For the cardholders associated with low probability cross-border cards, the computer initiates an action, including providing an offer to the identified cardholders of the low probability cross-border cards, wherein the offer incentivizes use the low probability cross-border cards in the destination country prior to, or during, the international travel.

According to the embodiments disclosed herein, a system is provided that uses historical transaction data and machine-learning to accurately differentiate cards that have a low probability of being used for cross-border transactions. These underutilized cards can then be profiled to identify a set of incentives to incorporate into new offers of benefits/products made to cardholders by payment systems providers and/or issuers to effectively promote cross-border transactions and generate revenue growth.

### BRIEF DESCRIPTION OF SEVERAL VIEWS OF THE DRAWINGS

FIG. 1 is a block diagram illustrating one embodiment for using machine-learning models to identify cardholders traveling abroad and to predict cardholder cross-border card usage to increase penetration of cross-border transactions.

FIG. 2 is a flow diagram illustrating a process for increasing penetration of cross-border transactions using machine-learning models.

FIG. 3 illustrates in further detail components of the payment systems provider, and in particular, the cross-border transaction promotion system according to some embodiments.

FIG. 4 is table showing example pseudo code logic performed by the travel destination logic to infer final destination airports based on different flight leg patterns.

FIG. 5 illustrates a table of example model attributes considered by the cross-border transaction propensity model.

FIG. 6A illustrates an example of a feedback table that tracks the outputs produced by the cross-border transaction promotion system and observed feedback.

FIG. 6B shows a case study table comparing information and spend behavior an ideal payment card and a payment card predicted to be a low probability cross-border card.

FIG. 7 is a diagram illustrating a high-level overview of the training mode and the production mode of the international travel classification model and the cross-border transaction propensity model.

FIG. 8 is a diagram illustrating an implementation of a computer system that may be applicable to computing devices of the issuer, the payment systems provider, merchant and/or the payment card.

### DETAILED DESCRIPTION

The exemplary embodiment relates to methods and systems for using machine-learning models to identify cardholders traveling abroad and predicting cardholder cross-border card usage to increase penetration of cross-border transactions. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The disclosed embodiments provide a framework for using machine-learning models to identify cardholders traveling abroad and to predict cardholder cross-border card usage to increase penetration of cross-border transactions. A first machine-learning model finds cardholders with a future international trip based at least on travel purchase transactions retrieved and travel itinerary records. For each of the cardholders found with the future international trip, a payment card used to purchase travel for the international trip, a destination country and a departure date are identified. A second machine-learning model uses as input the payment cards identified by the first machine-learning model and historical payment transaction information of the cardholders identify which ones of those payment cards are unlikely to be used for a cross-border payment transaction during the international trip versus those that are likely. For the payment cards that are unlikely to be used for the cross-border payment transaction, an action is taken, including offering the cardholders incentives to use the payment card during the trip, such as customized travel related local experiences.

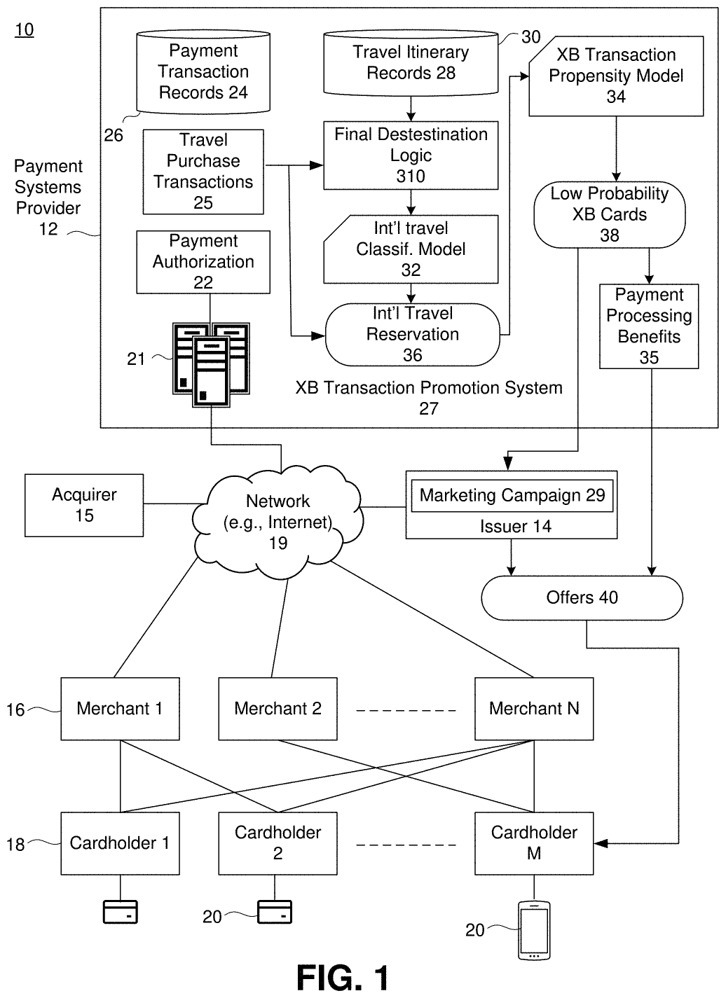

FIG. 1 is a block diagram illustrating one embodiment of a system 10 for using machine-learning models to identify cardholders traveling abroad and predicting cardholder cross-border card usage to increase penetration of cross-border transactions. The payment system 10 includes a payment systems provider 12, an issuer 14, a merchant 16, a cardholder 18, a payment card 20 and a network (e.g., Internet) 22.

The payment systems provider 12 may refer to an entity that receives transaction authorization requests from the merchant 16 and other entities and provides guarantees of payment, in some cases through an agreement between the payment systems provider 12 and the issuer 14. Examples of a payment systems provider may include as Visa®, MasterCard®, American Express®, or any other entity that processes credit card transactions, debit card transactions, and other types of commercial transactions. In some embodiments, an acquiring bank or acquirer 15 may forward the payment card details from the merchant 16 to the payment systems provider 12. Payment card transaction details sent over the network 19 are received by one or more servers 21 of the payment systems provider 12 and processed by, for example, by a payment authorization process 22, and/or forwarded to an issuer 14. Details of the payment card transaction may be stored as payment transaction records 24 in a transaction database 26.

The servers 21 or processors of the payment systems provider 12 may be organized into data processing subsystems, networks, and operations used to support and deliver payment related services (e.g., authentication services, authorization services, exception file services, and clearing and settlement services, etc.). The term server may refer to one or more computing devices, such as processors, storage devices, and/or similar computer components, that communicate with client devices and/or other computing devices over network 19, such as the Internet or private networks and, in some examples, facilitate communication among other servers and/or client devices. For example, the server computer can be a large mainframe, a minicomputer cluster, or a group of servers functioning as a unit. In one example, the server computer may be a database server coupled to a Web server, and may include or be coupled to a database.

The issuer 14 or card issuer, may refer to one or more entities that provide payment accounts to individuals (e.g., cardholders, customers, and/or the like) for conducting transactions, such as credit payment transactions and/or debit payment transactions. Typically, an issuer is a financial institution. The issuer 14 may provide an account or card identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, an issuer may also include reference to an “issuer system” comprising one or more computer systems operated by or on behalf of an issuer executing one or more software applications. For example, an issuer system may include one or more authorization servers for authorizing a transaction.

The payment systems provider 12 is in communication with the issuer 14 and the merchant 16 via network 19, which may comprise a private network or a public network, such as the Internet. As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively send information to the second unit. As another example, a first unit may be in communication with a second unit if at least one intermediary unit (e.g., a third unit located between the first unit and the second unit) processes information received from the first unit and sends the processed information to the second unit. In some non-limiting embodiments, a request or message may refer to a network packet (e.g., a data packet and/or the like) that includes data.

The merchant 16 may refer to one or more entities (e.g., operators of retail businesses) that provide goods and/or services, and/or access to goods and/or services, to a cardholder, based on a transaction, such as a payment transaction. As used herein “merchant system” may refer to one or more computer systems operated by or on behalf of a merchant, such as a server executing one or more software applications. The merchant 16 may include a point-of-sale (POS) device (not shown) that may be used by the merchant 16 to conduct and/or process transactions with cardholders.

The cardholder 18 is a user who is authorized to conduct transactions with the payment account provided by the issuer 14. The cardholder 18 can be, for example, the account owner of the account associated with a payment card, or an individual who is authorized to use the account on behalf of the account owner. The terms “cardholder” and “user” may be used interchangeably in the following description. The cardholder 18 initiates a transaction for goods/services of the merchant 16 using the payment card 20 associated with the payment account.

The payment card 20 (or simply “card” 20) may a physical instrument containing an account identifier associated with an account used for conducting transactions. Examples of a payment card include a credit card, debit card, charge card, gift card, loyalty card, smartcard, payroll card, healthcare card or any combination thereof. As another example, the payment card 20 may be an electronic device that is used to conduct transactions, such as a mobile phone using a wallet application, smart media, a wristband, a machine-readable medium containing account information, a keychain device or fob, or an RFID transponder. The payment card 20 may include a volatile or a non-volatile memory to store information (e.g., an account identifier, a name of the account holder, and/or the like). In another embodiment, the payment card 20 may include the computer the cardholder 18 uses to enter account information into to make an online purchase from a website of the merchant 16. A “card present” or a “face-to-face (F2F)” transaction” refers to a transaction in which a cardholder 18 uses the payment card 20 to interact physically with a payment system, such as POS terminal.

In some non-limiting embodiments, the issuer 14 may provide an account identifier (e.g., a PAN, a token, and/or the like) to the cardholder 18 that uniquely identifies one or more accounts associated with that user. As used herein, the term “account identifier” may refer to one or more types of identifiers associated with an account (e.g., a PAN associated with an account, a card number associated with an account, a payment card number associated with an account, a token associated with an account, and/or the like). The account identifier may be embodied on the payment card 20 (e.g., a payment card, a credit card, a debit card, a gift card, and/or the like) and/or may be electronic information communicated to the user for use during electronic transactions. Account identifiers may be alphanumeric, any combination of characters and/or symbols, and/or the like.

Once the cardholder 18 presents the account identifier to the POS device for a transaction, the POS device or other computer forwards the account identifier along with other transactional details, such as the payment amount, to the acquirer 15. As used herein, “acquiring” refers to functions supporting a merchant's needs in card payment acceptance, including POS terminals, software, a card processing, dispute management and merchant customer service. The acquirer 15 may route the transaction authorization requests to the payment systems provider.

The transaction authorization request is an electronic message that is sent to request authorization for a transaction. The transaction authorization request can be sent, for example, to the payment systems provider 12 and/or the issuer 14 of the payment card 20. The transaction authorization request may include an issuer account identifier that may be associated with the payment card 20 or payment account. The transaction authorization request may also comprise “transaction information,” including any information associated with a current transaction, such as the transaction amount, merchant identifier, merchant location, etc., as well as any other information that may be utilized in determining whether to identify and/or authorize a transaction.

After the payment systems provider 12 receives the transaction authorization requests, the payment systems provider 12 sends authorization data, e.g., payment authorization, to the appropriate issuer 12. The issuer 14 is configured to receive authorization data from the payment systems provider 12 (e.g., from an authorization server). Once the authorization data is received, the issuer 14 determines if the cardholder 18 is authorized to perform the given transaction (e.g., payment, cash deposit/withdrawal, money transfer, balance inquiries), and returns an authorization response message (not shown).

The authorization response message may be an electronic message reply to the transaction authorization request. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that the issuer 14 returns in response to transaction authorization request in an electronic message (either directly or through the payment systems provider) to the merchant's POS device indicating approval of the transaction. The code may serve as proof of authorization.

When an end party in one country, e.g., cardholder 18, conducts a payment card transaction with an end party, e.g., merchant 16, in another country, the transaction may be referred to as a cross-border transaction. Both consumers and businesses use payment cards to make cross-border payments and the ability to provide the service to international travelers is a major contributor to revenue, growth and success of the payment systems provider 12 and to the issuer 14.

According to the disclosed embodiments, the payment systems provider 12 is provided with a cross-border (XB) transaction promotion system 27 for increasing penetration of cross-border transactions. The cross-border transaction promotion system 27 comprises final destination logic 310 and two machine-learning models referred to as an international travel classification model 32 and a cross-border transaction propensity model 34.

In some embodiments, the payment systems provider 12 may accumulate transactional data for hundreds of millions of payment cards, such as credit cards, debit cards, prepaid cards, and the like. Corresponding records of the transactions are recorded in databases for settlement and financial record-keeping, such as payment transaction records 24 stored in the transaction database 26. The payment systems provider 12 may also access travel itinerary records 28, which may be segmented based on travel legs (e.g., flight/cruise legs). In one embodiment, the travel itinerary records 28 are stored in one or more travel-related databases 30 and/or reported by acquirers 15. The payment transaction records 24 and the travel itinerary records 28 can be mined and analyzed for trends, statistics, and other analyses.

According to the disclosed embodiments, this rich information can be used by (1) the international travel classification model 32 to identify cardholders 18 of payment cards 20 used to purchase an international reservation for travel in the near future, and by (2) the cross-border transaction propensity model 34 to identify which ones of those payment cards 20 have a low probability of being used for a cross-border purchase transaction during the trip. Payment cards that are unlikely to be used for a cross-border transaction are referred to herein as low probability cross-border cards 38.

Historical payment transaction records 24 of the cardholders of the low probability cross-border cards 38 can be further mined for specific marketing goals, such as to provide offers 40 or campaigns to cardholders 18 of the low probability cross-border cards 38 to promote use of those payment cards for a cross-border transaction during the trip. In one embodiment, the offers 40 are provided to the cardholders 18 before the international travel begins, but are applicable to cross-border transactions that occur during the trip. Example types of offers 40 may include limited offers for cross-border transactions, lower foreign transactions fees, and the like.

As fees charged by the payment systems provider 12 or the issuer 14 may be 3× to 4× higher than domestic transactions, offers 40 that encourage the use of low probability cross-border cards 38 may increase the revenue of the payment systems provider 12 and/or the issuer 14.

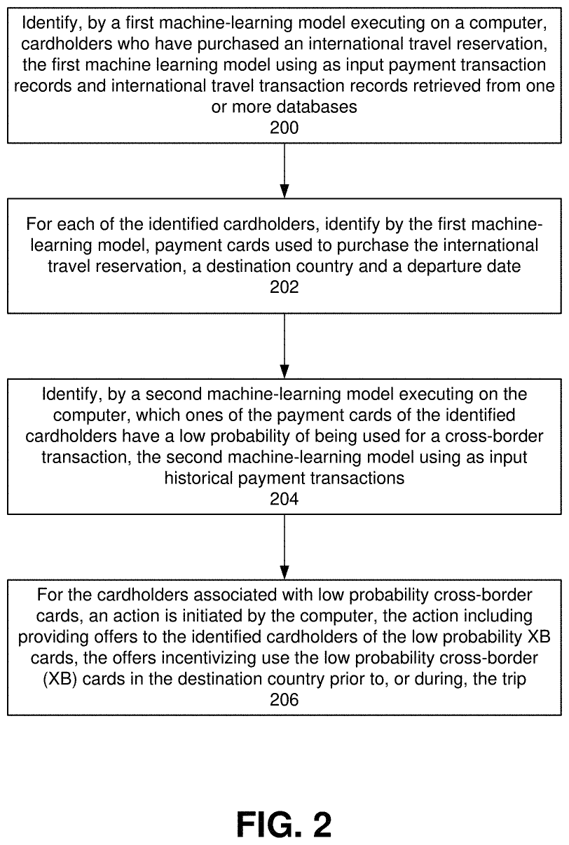

FIG. 2 is a flow diagram illustrating a process for increasing penetration of cross-border transactions using machine-learning models. The process may be implemented by the cross-border transaction promotion system 27 executing on a computer of the payment systems provider 12, such as one or more servers 21.

The process may begin by the a first machine-learning model executing on a computer identifying cardholders 18 of payment cards 20 used to purchase an international travel reservation 36, the first machine-learning model using as input the payment transaction records and travel itinerary records 28 retrieved from one or more databases (block 200).

In one embodiment, the first machine-learning model corresponds to the international flight classification model 32. The international flight classification model 32 may find the cardholders 18 by identifying payment cards 20 that were used by the cardholders 18 to purchase an international travel reservation 36 for travel occurring within a predetermined future time period, such as 1 to 3 months, for example.

The cross-border transaction promotion system 27 uses as inputs the payment transaction records 24 from the transaction database 26 and travel itinerary records 28 stored in one or more travel-related databases 30. More specifically, a subset of payment transaction records 24 referred to as travel purchase transactions 25 are used as input, where the travel purchase transactions 25 are payment transaction records related to travel reservation transactions. The transaction database 26 may be located at the payment systems provider 12 or elsewhere. Over time, the transaction database 26 may store historical transaction data (e.g., prior transaction data) and other information about the cardholders 18. For instance, the transaction database 26 may also store (or collect) various information regarding each of the cardholders 18, including detailed information of each purchase transaction, such as travel purchase transactions 25 initiated by the cardholder 18 using the payment card 20. This detailed information may then be stored as historical/past transaction data 24 for each of the users 18, which may be analyzed later by the payment systems provider 12.

The first machine-learning model also identifies a payment card used to purchase the international travel reservation 36 by the identified cardholders 18, and a corresponding destination country and a departure date identified (block 202).

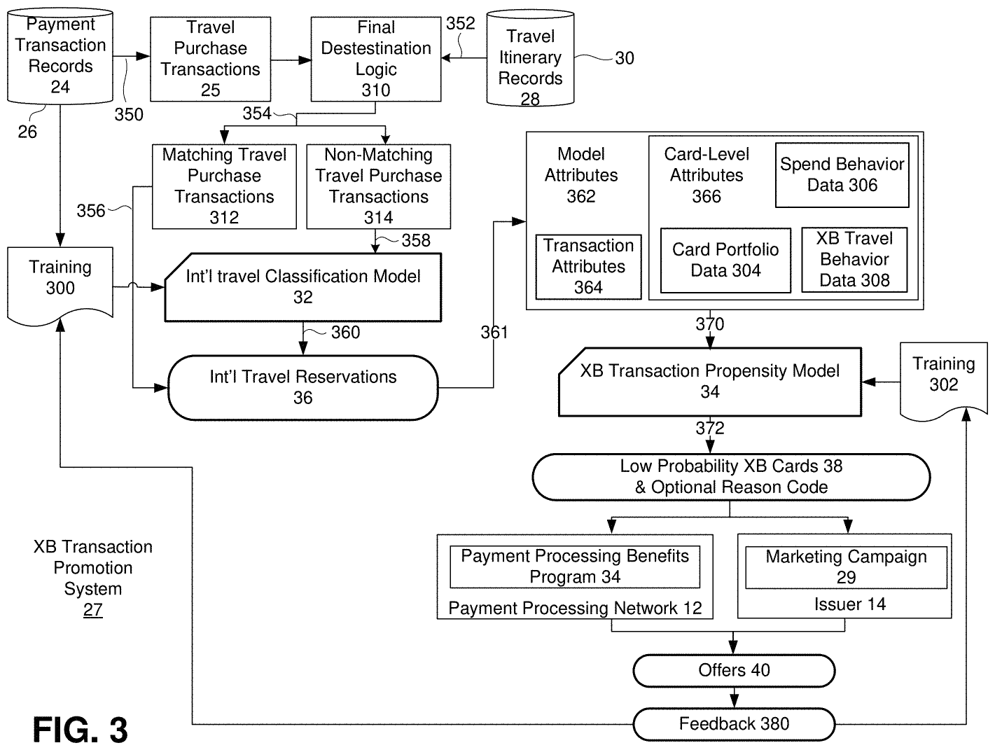

In one embodiment, in order for the international flight classification model 32 to classify a travel purchase transaction 26 as between an international travel reservation and a domestic travel reservation, the final travel destination must be identified. Therefore, in one embodiment, the final destination logic 310 analyzes the travel itinerary records 28 together with the travel purchase transactions 25 to determine a final destination of the travel, as explained with reference to FIG. 3. From the final destination, a destination country can be determined. The travel itinerary records 28 may refer to flights, cruises, or trains that have multi-leg segments or stops. A multi-leg segment for a flight reservation refers to a flight leg, which is defined as a trip of an aircraft from one airport to another. Similarly, a multi-leg segment for a cruise reservation refers to a cruise leg, which is defined as a trip of a ship from one port to another. In one embodiment, the travel itinerary records 28 may be retrieved from an acquirer database or a travel-related database (e.g., airline/train/cruise reservation system). Although the disclosed embodiments are described in terms of identifying a destination country from the final destination, the cross-border transaction promotion system 27 may instead identify another type of destination geographical region such as a state, a province, a city, a county, and the like.

Based on input from the travel purchase transactions 25, the travel itinerary records 28 and the final travel destinations or destination countries, the international flight classification model 32 can identify the payment cards 20 used by their cardholders 18 to purchase the international travel reservation 36 for an impending trip.

A second machine-learning model executing on the computer identifies which ones of the payment cards of the identified cardholders have a low probability of being used for a cross-border transaction (referred to herein as low probability cross-border (XB) cards 38), the second machine-learning model using as input historical payment transactions from the transactions database 26 (block 204).

In one embodiment, the second machine-learning model corresponds to the cross-border transaction propensity model 34. In one embodiment, the analysis performed by the cross-border transaction propensity model 34 may be based both the output of the international flight classification model 32 and the historical payment transactions from the transactions database 26. In one embodiment, the cross-border transaction propensity model 34 generates and outputs a list of the low probability XB cards 38.

For the cardholders 18 associated with low probability cross-border cards 38, the computer initiates an action, including providing an offers 40 to the identified cardholders 18 of the low probability XB cards 38, the offers incentivizing use the low probability cross-border (XB) cards in the destination country prior to, or during, the international travel (block 206).

The cross-border transaction promotion system 27 can analyze these low probability cross-border (XB) cards 38 to identify one or more incentives to build into new or personalized offers 40 provided to the cardholders 18 by the payment systems provider 12 or the issuer 14 prior to the departure date of the international travel to promote future use of the low probability cross-border (XB) cards 38. In another embodiment, the offers 40 may be sent to the cardholder during international travel based on real-time location data of the cardholders. In one embodiment, a single offer could be sent to a group or all of the cardholders. In another embodiment, at least a portion of the offers 40 are customized for one or more of the cardholders 18.

As shown in FIG. 1, the list of low probability cross-border cards 38 may be forwarded to a payment processing benefits program 35 of the payment systems provider 12 so that the payment systems provider 12 may directly offer the cardholders customized travel related experiences in the destination country. The list of low probability XB cards may also be forwarding to a marketing campaign 29 of the issuer 14 so that the issuer 14 can make offers/incentives to the cardholders 18. Either way, the goal of the target action is to modify cardholder behavior in favor of using the low probability cross-border cards for cross-border transactions.

Both the international travel classification model 32 and the cross-border transaction propensity model 34 may be implemented using multiple types of predictive models. However, according to the disclosed embodiments, the international travel classification model 32 may be implemented using a random force model to achieve at least 88% accuracy and 91% area under the curve (AUC); and the cross-border transaction propensity model 34 may be implemented using a gradient boosting tree model to provide at least 70% accuracy and 84% AUC.

FIG. 3 illustrates in further detail components of the payment systems provider 12, and in particular, the cross-border transaction promotion system 27 according to some embodiments. The cross-border transaction promotion system 27 is an interconnected process to identify cardholders 18 that have used a payment card 20 to purchase a reservation for international travel and to predict their subsequent cross-border card usage.

In embodiments, the cross-border transaction promotion system 27 operates in two modes, a training mode and a production mode. The training mode includes a first training session 300 to train the international travel classification model 32 using a first set training data, and a second training session 302 to train the cross-border transaction propensity model 34 using a second set training data, as explained further below. After the training mode, the cross-border transaction promotion system 27 uses the international travel classification model 32 and the cross-border transaction propensity model 34 during the production mode to ultimately generate offers 40 to cardholders 18 to promote cross-border transactions using a payment cards 20.

During the production mode, the cross-border transaction promotion system 27 first identifies cardholders 18 who have purchased international travel reservation (also referred to as a cross-border trip) using a payment card. In one embodiment, the purchases are limited those made within a predetermined amount of time in the past (some number of days, weeks or months) for travel at a future point in time from the present.

The process of identifying cardholders 18 who have a cross-border trip includes extracting travel purchase transactions 25 from the payment transaction records 24 (at operation 350). The travel purchase transactions 25 are a subset of the payment transaction records 24 that refer to transportation-related payment transactions that could be used for international travel, such as for airline, cruise or train tickets for example. Example types of data from each of the travel purchase transactions 25 that may be input to the international travel classification model 32 include a PAN, a transaction amount, a purchase merchant, and the like. In one embodiment, the travel purchase transactions 25 may be extracted from the payment transactions records 24 based on the PAN, purchase merchant (i.e., merchant category group and merchant name) and transaction amount.

The final destination logic 310 also retrieves travel itinerary records 28 from one or more travel databases 30 (at operation 352).

The final destination logic 310 then finds matches between the travel purchase transactions 25 and the travel itinerary records 28, and determines for the matching travel purchase transactions 312, a departure country, a final destination country and a departure date, based at least in part on analyzing the corresponding travel itinerary records 28 (at operation 354).

The travel purchase transactions 25 may be matched or joined to the travel itinerary records 28 by grouping different travel legs by PAN and transaction sequence IDs. In one embodiment, the different travel legs grouped by the PAN further have departure dates that are within +/−1 day of each other.

The travel itinerary records 28 may may be segmented based on travel legs (e.g., flight/cruise legs). The travel itinerary records 28 may indicate for each travel leg, at least a destination and a departure date. In one embodiment, the destination may be identified as a city, airport or seaport, but may be converted to a destination country. The travel itinerary records 28 may be reported by acquirers, and the final destination logic 310 may access the travel itinerary records 28 periodically, such as hourly, daily, and the like. Some of the matching travel purchase transactions 25 may have multi-leg segments, whether domestic or international.

The final destination logic 310 determines the final destination country of a trip to distinguish between international travel reservations 36 from domestic travel reservations. According to one aspect of the disclosed embodiments, the final destination logic 310 infers the final destination country by examining travel legs comprising the travel itinerary records 28 associated with the same payment card or PAN. Responsive to determining that travel leg(s) associated with the same payment card are non-stop or one-way with no stops, the final destination logic 310 infers that a destination of the non-stop or the one-way travel leg is the final destination of the international travel reservation. For travel legs that are non-stop or one-way with no stops, there is only one destination (e.g., an airport or seaport), so the destination of the non-stop or the one-way travel-leg is inferred to be the final destination of the international travel reservation.

However, when multiple travel itinerary records 28 are associated with the same PAN define one way and round trips with multiple stops, the final destination logic 310 analyzes the travel-leg pattern of the multiple travel itinerary records 28 to infer the final destination. Responsive to determining that the travel legs associated with the same payment card define a multiple travel-leg pattern, the final destination logic 310 determines whether the multiple travel-leg pattern comprises a one-direction leg pattern or asymmetrical leg pattern. Multiple travel-legs that move to one direction are regarded as a one-way trip and the last destination is inferred as being the final destination. For example, for the one-direction leg pattern ATL-IST-LGW, the last destination LGW (London) is as inferred as being the final destination.

For the symmetrical leg pattern, the final destination logic 310 analyzes the symmetry of the multiple travel-leg pattern and infers that the destination of the travel-leg in the middle of the travel-leg pattern is the final destination. For example, assume that multi-leg travel records define flight legs of SFO-YYZ-DXB-YYZ-SFO. This would be identified as a symmetrical leg pattern since it begins and ends with the same city. The middle leg identifies the airport DXB, which is in the country of Dubai, and thus Dubai is inferred to be the final destination.

Finally, the travel destination logic 310 determines the final destination country from the final destination, which may be represented as an airport code or city, and appends to the corresponding travel purchase transactions 25 the final destination country and optionally the arrival time.

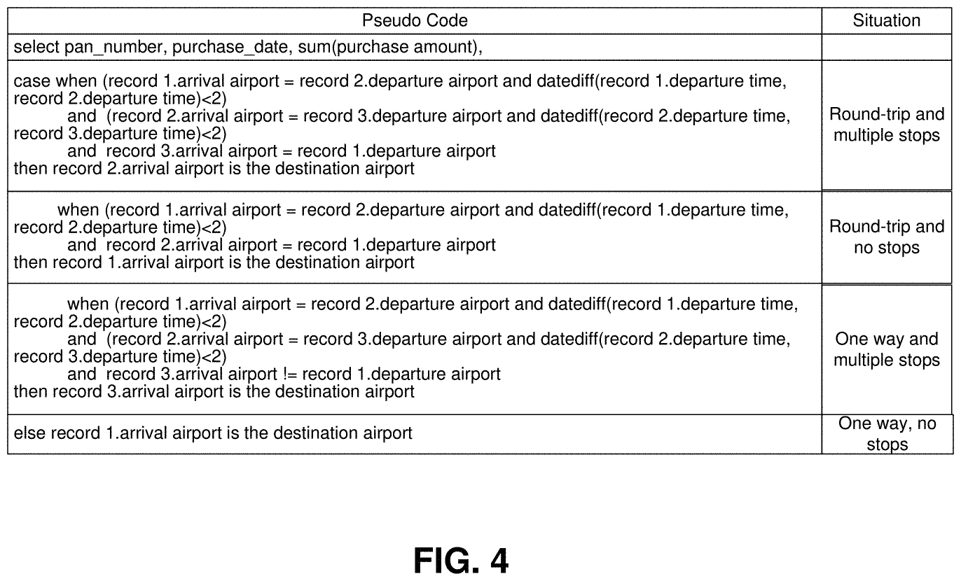

FIG. 4 is table showing example pseudo code logic performed by the travel destination logic 310 to infer final destination airports based on different flight leg patterns the logic analyzes the leg patters based on round-trip and multiple stops, round-trip and no stop, one-way and multiple stops, and one-way and no stop. Flight legs 1, 2, 3, are referred to by record 1, record 2. etc., and include an arrival airport and a departure airport for each leg. Stops between flights of the same trip are defined as flight leg records having less than two days separating departure times. In one embodiment, an initial SQL query for records from the travel leg records may be:
SELECT pan_number, purchase_date, sum (purchase amount)
FROM flight database
WHERE transaction time is in [a specified date range]
GROUP BY pan_number, purchase_date.

Referring again to FIG. 3, after the final destinations and final destination countries are determined, the final destination logic 310 identifies the matching travel purchase transactions 312 with known travel information as international travel reservations 36 when the departure country is different than final destination country (at operation 356). A high percentage (e.g., 65-75%) of the final travel destinations can be determined directly from the matching travel purchase transactions 312 due to the known travel information. However, the remaining 25-35% comprise travel purchase transactions 25 that were not matched with any of the travel itinerary records 28 (i.e., non-matching travel purchase transactions 314) and therefore have unknown travel information such as a final destination.

According to one aspect of the disclosed embodiments, the international travel classification model 32 is applied to the non-matching travel purchase transactions (at operation 358) to infer which ones of the non-matching travel purchase transactions 314 comprise international travel reservations 36 (i.e., a cross-border trip) based on attributes including, travel purchase amount and a purchase merchant (i.e., merchant category group and merchant name) (at operation 360).

Example transactions attributes from the travel purchase transactions 25 analyzed by the international flight classification model 32 include the transaction amount, the purchase merchant among other possible attributes. During the analysis, the international flight classification model 32 weights the transaction attributes of the travel purchase transactions 25 to determine which travel purchase transactions 25 are international travel reservations 36. For example, travel purchase transactions 25 having a higher transaction amount relative to others are more likely to indicate an international travel reservation, while a purchase merchant of “United Airlines” are more likely to be an international flight purchase since United Airlines operates worldwide.

The international travel classification model 32 may produce a binary output identifier indicating for each individual travel purchase transactions 25, which ones of the travel purchase transactions 25 are international travel reservations 36, and may optionally indicate which ones are domestic travel reservations in one embodiment. In one embodiment, the binary output identifier may be appended to the record corresponding to the travel purchase transaction 25. In one embodiment, the binary output identifier may be implemented as a text label, a number, an alphanumeric value, an icon or the like. For example, a text label for international travel may be “INTL”, while the text label for domestic travel may be “DOM”.

The process above may result in a list of travel purchase transactions 25 identified as the international travel reservations 36. As the travel purchase transactions 25 include the PANs of payment cards 20 used to purchase international travel reservations 36, the corresponding cardholder 18 who have purchased an international travel reservation (e.g., for a flight or cruise ticket) can also be identified.

For the travel purchase transactions 25 identified as international travel reservations 36, the cross-border transaction propensity model 34 is applied to generate a score indicating a probability of the corresponding payment card being used by the identified cardholder for a subsequent cross-border payment transaction. To do so, the travel purchase transactions 25 identified as international travel reservations 36 are used to create model attributes 362 (at operations 361) that are input to the international travel classification model 32 (at operation 370).

In one embodiment, the model attributes 362 may comprise transaction attributes 364 and card-level attributes 366. As described further above, example transactions attributes 364 may include a travel purchase amount and a purchase merchant (i.e., merchant category group and merchant name).

The card level attributes 366 may include card portfolio data 304, spend behavior data 306, and cross-border travel behavior data 308. In one embodiment, the card-level attributes 366 may be retrieved from historical payment transaction records 24 based on the PAN. The card portfolio data 304 may identify a product type (e.g., card type) and fees (foreign transaction fees and annual fees) associated the type of card. The cross-border travel behavior data 308 may leverage a payment card's travel related behaviors over a period of time, such as over a year. Information in the cross-border travel behavior data 308 may include a number cross-border travel days, a number of cross-border trips, total spend during cross-border travels, and the like.

In one embodiment, a payment card's spend behavior data 306 may be segmented based on various merchant categories over the past year, such as total spend in hotels, car rentals, and the like. In some embodiments, the transaction database 26 may include historical payment transaction data or associated with the following spend categories: the overall usage of the payment card 20, the overall usage of the payment card 20 on travel and entertainment, the overall usage of the payment card 20 on retail. These spend behavior data 306 may further include one or more transaction attributes.

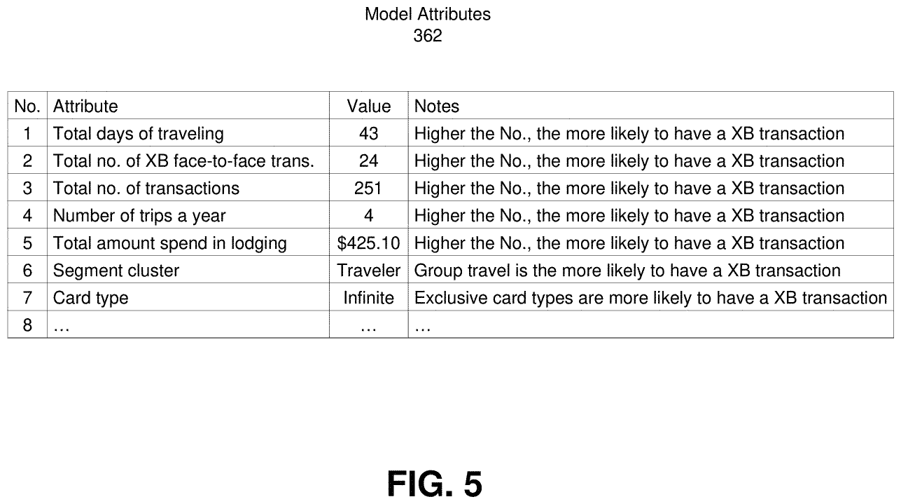

FIG. 5 illustrates a table of example model attributes 362 considered by the cross-border transaction propensity model 34. In this example, seven example attributes are shown along with corresponding values for a particular payment card. The notes column describes how each of the attributes is considered/weighted by the cross-border transaction propensity model 34 when calculating whether a particular card will be used for a subsequent cross-border transaction.

As a further example, in specific embodiments the model attributes 362 may include: a frequency of transactions, a transaction spend, a consistency of usage, a frequency or amount of electronic commerce transactions, a frequency or amount of airline transactions, a frequency or amount of travel service transactions, a frequency or amount of lodging transactions, a frequency or amount of retail transactions, a frequency or amount of restaurant transactions, a frequency or amount of general retail transactions, a frequency or amount of apparel retail transactions, a frequency of transactions in the at least one target region, a transaction spend in the at least one target region, a consistency of transactions in the at least one target region, past travel behavior (or patterns), merchant preferences, an amount or frequency of seasonal purchases, a number of channels through which a cardholder 18 has initiated a transaction, spend behavior, and/or any combination thereof. It will be appreciated that this list of model attributes 362 may not be limited to those described.

Referring again to FIG. 3, the model attributes 362 may be used by the cross-border transaction propensity model 34 to understand cardholder cross-border travel behaviors, durations between purchase and departure, popular corridors, benchmark of airlines/cruise lines ticket price, foreign transaction fees and annual fees, and the like. The foreign transaction fees and annual fees for majority of card portfolios may obtained from data stored by the payment systems provider 12, or alternatively, gathered from the Internet through, for example, a web scraping service. During both model training and the production mode, the data comprising the model attributes 362 may be integrated from different sources together to make more accurate predictions. During processing by the cross-border transaction propensity model 34, cardholders 18 identified as cross-border travelers may be segmented based on subsequent spend behaviors, for example, a heavy international traveler that doesn't use a particular type of payment card, versus use of only a particular type of payment card, versus use of multiple different types of payment cards for cross-border purchases.

Given this input, the cross-border transaction propensity model 34 predicts the probability of the payment cards 20 of the identified cardholders being used for cross-border transactions. For each cross-border trip and for each payment card/cardholder, the cross-border transaction propensity model 34 generates a score. In one embodiment, the scores correlates to a probability, in which case the score may range from 0 to 100. Some payment cards may score for example a 95% probability that the card will be used for a cross-border transaction, while another card may score a 10% probability. Higher scores indicate ideal cardholders, but cardholders having relatively lower scores, the cross-border transaction promotion system 27 can initiate offers 40 to entice the cardholders to use the cards for cross-border transaction during the cross-border trip.

In one embodiment, the scores may be compared to a threshold score. As one example, a payment card may be included on a list of low probability cross-border cards 38 if the payment card has a score or probability less than a probability score threshold of 20-30% of being used during the cross-border transaction. Alternatively, values of the scores may be flipped such that a payment card is considered a low probability cross-border card if the card's score exceeds the score threshold. The score threshold can be set based on different use cases. In one embodiment, the score threshold may be determined based on model accuracy and the particular campaign performance requirement. For example, expensive campaigns requiring higher accuracy may have a higher probability score threshold than less expensive campaigns. In one embodiment, the scores may be stored in a database at various levels such as native transaction level or rolled up to a card or consumer level, the can be used for the purposes, such as profiling and benchmarking.

In one embodiment, the cross-border transaction propensity model 34 outputs a list of low probability cross-border cards 38, i.e., payment cards having a score indicating a low probability (at operation 372). The list may further include for each card, the score and optionally a reason code of why the cardholder does not use the payment card for cross-border transactions. Sending the reason code enables the offers 40 to encourage cardholders to use the payment cards for cross-border transactions to be more targeted to the cardholders 18.

The list of low probability cross-border cards 38 output by the cross-border transaction propensity model 34 is passed to one or more downstream processes to initiate an action, such as profiling the payment cards having a relatively low probability to identify a set of incentives to incorporate into new offers 40 of benefits or products made to cardholders 18. For example, offers 40 may be distributed that target the cardholders 18 of the low probability cards 38 to increase use of those cards for subsequent cross-border transactions. The offers 40 may comprise products solutions customized to cross-border traveler's needs, such as time-limited offers for cross-border transactions, lower foreign transaction fees, bonus points, discounts, recommendation services, concierge services and the like.

In one embodiment, the offers 40 may be sent to the cardholders directly by the payment processing benefits program 35 of the payment systems provider 12, indirectly by the marketing campaigns 29 of issuers 14 of the corresponding payment cards, or both. In one embodiment, the cross-border transaction promotion system 27 may forward the list of local ability cross-border cards 38 to the issuers 14 via an application programming interface (API) (not shown).

Examples of the type of offers made by the payment systems provider 12 may include custom must travel related local experiences, such as VIP fine dining restaurant reservations, local show seat upgrades, cross-border luxury shopping delivery services, recommended local restaurants, an entertainment activities based on similar group of people that the spin categories similar to the cardholder and the like. Examples of types of offers made by the issuers 14 may include offers and encourage the cardholders to use the payment cards for cross-border transactions, such as coupons sent via more applications or email, lower foreign transaction fees, bonus points or cash by for a certain time-period of cross-border transactions, and the like.

In one embodiment, the offers 40 may be initiated prior to the departure date associated with the international travel purchase transactions. In another embodiment, the offers 40 may be made to the cardholders once at their final destination as determined by the cardholder's real-time location data. In one embodiment, the location data can be obtained from an electronic wallet application running on the cardholder's mobile device, where the wallet application may correspond to the payment card, the payment systems provider 12 or the issuer 14.

In a further aspect of the disclosed embodiments, after offers 40 are made to cardholders 18, the cross-border transaction promotion system 27 collects feedback 380 that tracks usage of the low probability cross-border cards for subsequent cross-border transactions. For example, through the issuer API, the system can receive from the issuers 14 the actions taken by the issuers. The system can also monitor incoming payment transaction records 24 to track an observed cross-border transactions by the payment cards. The feedback can then be use to update international travel classification model 32 and the cross-border transaction propensity model 34.

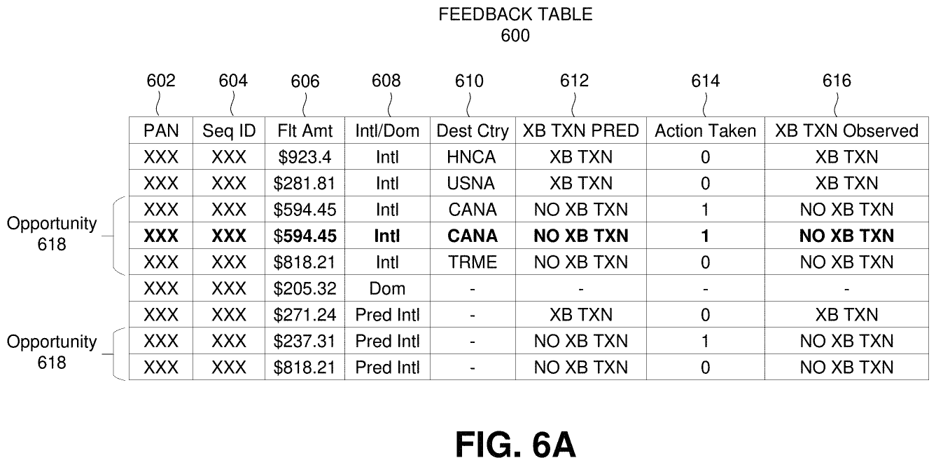

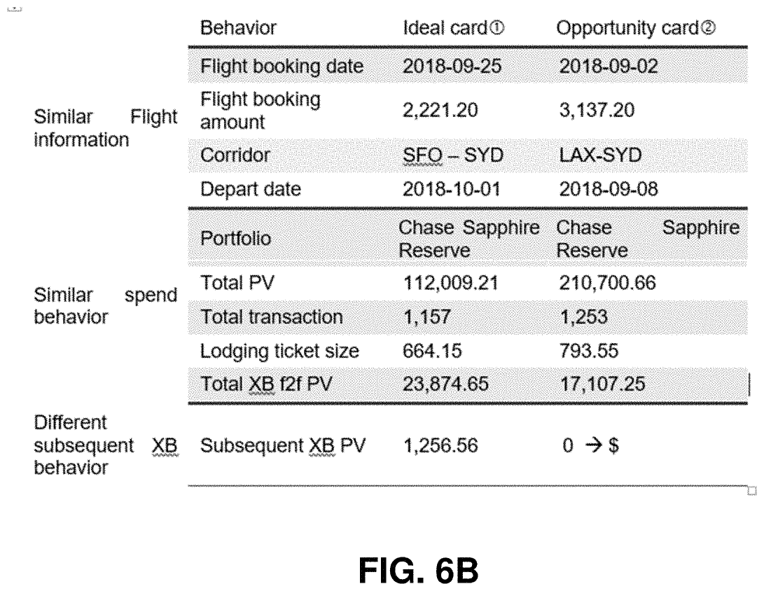

FIG. 6A illustrates an example of a feedback table 600 that tracks the outputs produced by the cross-border transaction promotion system 27 and observed feedback. In one embodiment, the feedback table 600 may include the following fields: a PAN field 602, a sequence ID field 604, a transaction amount field 606, international/domestic travel (Intl/Dom) field 608, destination country field 610, cross-border transaction predicted field 612, an action taken field 614 and a cross-border transaction observed field 616.

Values for the PAN field 602, the sequence ID field 604, a transaction amount field 606 and the may be populated from the travel purchase transactions 25 used to purchase the travel reservations. The values for the international/domestic travel (Intl/Dom) field 608 are output from the international travel classification model 32 and indicate whether the travel reservations are for domestic or international (cross-border) travel. The value “predicted international” (Pred. Intl) represents a transaction classified as international travel by the international travel classification model 32.

The destination country field 610 indicates the final destination country of the travel. Values for the cross-border transaction predicted field 612 are output from the cross-border transaction propensity model 34 and indicate if the travel reservation is predicted to be cross-border travel. The action taken field 614 is a flag indicating if an action of sending an offer to the cardholder was taken or not. Values for cross-border transactions observed field 616 indicates whether the corresponding payment card was actually used for a subsequent cross-border transaction.

The transaction records flagged as having international travel in the international/domestic travel (Intl/Dom) 608 field and having a low probability of having a subsequent cross-border transaction, as indicated in the cross-border transaction predicted field 612, represent an opportunity 618 for the system to send an offer 40 to the corresponding cardholders to increase cross-border payment card usage.

The record in bold is an example of an international travel reservation in which no cross-border transaction was predicted, and an action was taken in response, such as an offer 40 being sent to the cardholder. The feedback obtained indicated that the payment card was never used for a subsequent cross-border transaction, shown in the cross-border transaction observed field 616.

FIG. 6B shows a case study table comparing information and spend behavior an ideal payment card and a payment card predicted to be a low probability cross-border card. The low probability cross-border card is referred to as an opportunity card since it represents an opportunity for the payment systems provider 12 and issuers 14 to offer targeted promotions to encourage cardholders to use the same card for subsequent cross-border purchases.

In the case study table, both the ideal card and the opportunity card are Chase Sapphire Reserve cards, and both have similar flight information and similar spend behavior. The opportunity card cardholder purchased a flight reservation from Los Angeles to Sydney on Sep. 2, 2018 for $3137.20, with a departure date of Sep. 8, 2018. The cardholder of the ideal card has also purchased a similar flight reservation on a similar date with a similar departure date. However, the spend behavior shows that the opportunity card cardholder has much less of historical cross-border face-to-face transactions than the cardholder of the ideal card. Based on the historical cross-border spend behaviors, the cross-border transaction propensity model 34 predicts a low probability that cardholder will use the opportunity card for subsequent cross-border transactions, shown as $0. Therefore, the cross-border transaction promotion system 27 determines there is higher likelihood of the cardholder of the opportunity card can be prompted to use the payment card for future cross-border transactions. Thus, after purchase of the flight reservation, the cross-border transaction promotion system 27 may send the card identifier (e.g., a PAN) and travel information to an issuer so the issuer can take instant action, like offering lower foreign transactions fee (if any). The payment systems provider 12 may also offer some destination related local experience for customized benefits. Preferably, the offers 40 are sent to the cardholders prior to the departure date so that the cardholder is made the awards before the trip, and are more likely to use this card for cross-border transactions.

As stated further above, feedback data, such as shown in feedback table 600, can be input to the international travel classification model 32 and the cross-border transaction propensity model 34 for further training by training processes 300 and 302, respectively, to improve the performance of the models based on observed transaction data, and to measure the efficiency of the offers 40 made to the cardholders. Feedback 380 transforms the cross-border transaction promotion system 27 into a dynamic closed-loop system in which the prediction provided by the models 32 and 34, the promotion of the offers 40, and subsequent feedback 380, spiral smoothly.

It should be noted that a cardholders' spend behavior might change with time goes by. Therefore, the data fed into model variables, such past on year cross-border travel records, past one-year spend behavior, may need to be refreshed monthly in one embodiment. However, given the thousands of travel purchase transactions processed by the payment systems provider 12, the travel purchase transactions may need to be refreshed daily in one embodiment. Such timing allows the capture of cardholder cross-border travel intentions and the promotion of subsequent payment card usage in time for the international trip. Since, the cross-border transaction promotion system is a close-loop eco-system, the models 32 and 34 may be updated based on feedback responses monthly. Thus, when combining these three parts together from the production mode perspective, an automatic data streaming/retrieval system is provided to execute monthly long-term profile updates, daily model applications and business applications, and monthly model improvement.

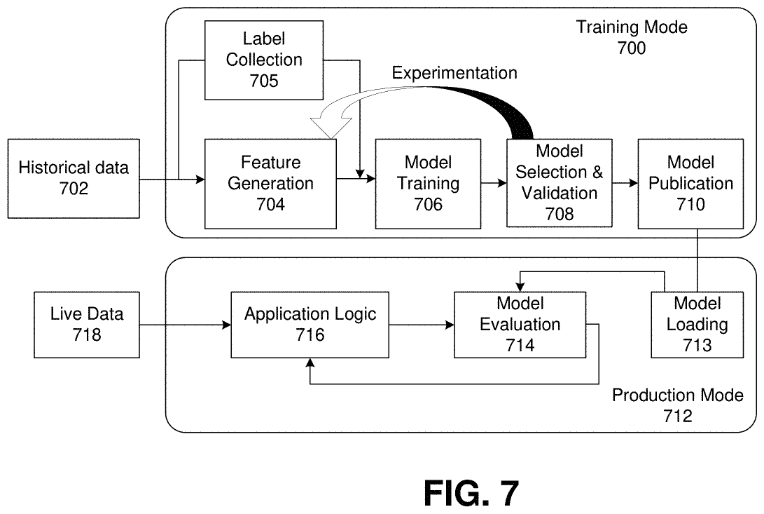

FIG. 7 is a diagram illustrating a high-level overview of the training mode and the production mode of the international travel classification model 32 and the cross-border transaction propensity model 34. During the training mode 700, both the training sessions 300 and 302 (FIG. 3) performed on the international travel classification model 32 and the cross-border transaction propensity model 34, referred to as the models 32 and 34, operate as shown. Historical data 702 is received is used as input to a feature generation process 704 to generate features, such as cross-border face-to face transactions, number of payment volumes, and transactions. In one embodiment, the same type of data may be used during training mode that is used for production mode, except in training mode, the data is historical, while in production mode, the data is live or current. For example, during training, historical payment transaction records may be used for at least part of the historical data 702.

Label collection 705 is also performed on historical data 702 to generate labels. This process may be integrated to determine which input variables to include for model training 706. The selected input variables are then used during model training 706 to train a plurality of models to determine which model(s) to use based on performance and accuracy. Model selection and validation 708 is performed to select the best models and validate model performance using test data. In one embodiment, AUC (area under the ROC curve) may be used as an aggregate measure of performance across possible classification thresholds. The model selection and validation 708 may be an iterative process with the feature generation 704 and model training 706 in which different variables and models are experimented with, as shown. Once the best model is chosen, the model is input to model publication 710 for publication.

During the production mode 712, the published model is input to model loading 713, which loads the model for execution. Live data 718 is input to application logic 716 to generate the model attributes that are then input to the running model. Model evaluation 714 incorporates any feedback 380 (FIG. 3) received and inputs any insights to the application logic, and the model is evaluated again.

Business Alignment

The Cross-border transaction promotion system 27 focuses on cardholders' international travel behaviors and further supports consumer credit product and benefit design in the context of promoting usage of payment cards for cross-border purchases. Given this, the payment systems provider 12 may actively, comprehensively, and accurately generate the list of cards that already booked international travel but likely have no subsequent cross-border transactions. The output can lead to very actionable insight and productive campaign design and execution compared to traditional approach.

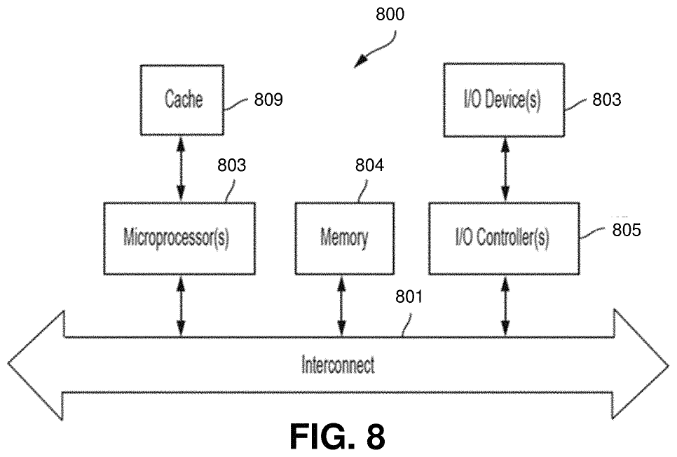

FIG. 8 is a diagram illustrating an implementation of a computer system 800 that may be applicable to computing devices of the payment systems provider 12, the issuer 14, merchant 16 and/or the payment card 20. According to an embodiment. The computer system 800 can include a microprocessor(s) 803 and memory 802. In an embodiment, the microprocessor(s) 803 and memory 802 can be connected by an interconnect 801 (e.g., bus and system core logic). In addition, the microprocessor 803 can be coupled to cache memory 809. In an embodiment, the interconnect 801 can connect the microprocessor(s) 803 and the memory 802 to input/output (I/O) device(s) 805 via I/O controller(s) 807. I/O devices 805 can include a display device and/or peripheral devices, such as mice, keyboards, modems, network interfaces, printers, scanners, video cameras and other devices known in the art. In an embodiment, (e.g., when the data processing system is a server system) some of the I/O devices (805), such as printers, scanners, mice, and/or keyboards, can be optional.

In an embodiment, the interconnect 801 can include one or more buses connected to one another through various bridges, controllers and/or adapters. In one embodiment, the I/O controllers 807 can include a USB (Universal Serial Bus) adapter for controlling USB peripherals, and/or an IEEE-1394 bus adapter for controlling IEEE-1394 peripherals.

In an embodiment, the memory 802 can include one or more of: ROM (Read Only Memory), volatile RAM (Random Access Memory), and non-volatile memory, such as hard drive, flash memory, etc. Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DV D RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of the present disclosure.

A framework for using machine-learning models to identify cardholders traveling abroad and to predict cardholder cross-border card usage to increase penetration of cross-border transactions has been disclosed. The present invention has been described in accordance with the embodiments shown, and there could be variations to the embodiments, and any variations would be within the spirit and scope of the present invention. Accordingly, many modifications may be made by one of ordinary skill in the art without departing from the spirit and scope of the appended claims.

We Claim:

A computer-implemented method, comprising:
identifying, by a first machine-learning model executing on a computer, cardholders who have purchased an international travel reservation, the first machine-learning model using as input payment transaction records and travel itinerary records retrieved from one or more databases;
for each of the identified cardholders, identifying by the first machine-learning model, a payment card used to purchase the international travel reservation, and a corresponding destination country and a departure date;
identifying, by a second machine-learning model executing on the computer, the payment cards of the identified cardholders having low probability of being used for a cross-border transaction, the second machine-learning model using as input historical payment transactions; and
for the cardholders associated with low probability cross-border cards, initiating by the computer, an action including providing offers to the identified cardholders of the low probability cross-border cards, the offers incentivizing use the low probability cross-border cards in the destination country prior to, or during, the international travel.

2. The computer-implemented method of claim 1, wherein using as input payment transaction records, further comprises: using travel purchase transactions that are a subset of the payment transaction records related to travel reservation transactions.

3. The computer-implemented method of claim 2, wherein the identified cardholders who have purchased the international travel reservation, further comprises: analyzing the travel purchase transactions together with the travel purchase transactions to identify a final destination of the travel.

4. The computer-implemented method of claim 3, further comprising: determining the destination country from the final destination.

5. The computer-implemented method of claim 1, wherein identifying the payment cards of the identified cardholders having a low probability of being used for the cross-border transaction further comprises: generating a list of low probability cross-border cards.

6. The computer-implemented method of claim 5, wherein providing the offers to the identified cardholders of the low probability cross-border cards further comprises at least one of: sending the offers to the cardholders by a payment systems provider or forwarding the list of low probability cross-border cards to an issuer for the issuer to send to the offers.

7. The computer-implemented method of claim 6, wherein providing the offers to the identified cardholders further comprises: sending the offers at least one of: prior to the departure date of the international travel or during the international travel based on real-time location data of the cardholders.

8. The computer-implemented method of claim 1, further comprising:
after the offers are provided to the cardholders, collecting feedback that tracks usage of the low probability cross-border cards for subsequent cross-border transactions; and
using the feedback to update the first machine-learning model and the second machine-learning model.

9. The computer-implemented method of claim 1, wherein the identified cardholders who have purchased the international travel reservation, further comprises: identifying the payment cards used by the cardholders to purchase the international travel reservation for travel occurring within a predetermined future time period.

10. The computer-implemented method of claim 1, further comprising: using the historical payment transactions to create model attributes for input to the second machine-learning model, the model attributes comprising transaction attributes and card level attributes.

11. The computer-implemented method of claim 1, further comprising: implementing the first machine-learning model as an international flight classification model based on a random force model.

12. The computer-implemented method of claim 1, further comprising: implementing the second machine-learning model as a cross-border transaction propensity model based on a gradient boosting tree model.

13. A system, comprising:
a memory;
a computer processor coupled to the memory; and
a first machine-learning model and a second machine-learning model executed by the computer processor that are configured to:
identify, by the first machine-learning model, cardholders who have purchased an international travel reservation, the first machine-learning model using as input payment transaction records and travel itinerary records retrieved from one or more databases;
for each of the identified cardholders, identify by the first machine-learning model, a payment card used to purchase the international travel reservation, and a corresponding destination country and a departure date;
identifying, by the second machine-learning model, the payment cards of the identified cardholders having low probability of being used for a cross-border transaction, the second machine-learning model using as input historical payment transactions; and
for the cardholders associated with low probability cross-border cards, initiating by the computer processor, an action including providing offers to the identified cardholders of the low probability cross-border cards, the offers incentivizing use the low probability cross-border cards in the destination country prior to, or during, the international travel.

14. The system of claim 13, wherein the offers are sent to the cardholders by a payment systems provider or a list low of the probability cross-border cards is forwarded to an issuer for the issuer to send to the offers.

15. The system of claim 14, wherein providing the offers to the identified cardholders of the low probability cross-border cards further comprises: sending the offers at least one of: prior to the departure date of the international travel or during the international travel based on real-time location data of the cardholders.

16. The system of claim 15, wherein after the offers are provided to the cardholders, feedback is collected that tracks usage of the low probability cross-border cards for subsequent cross-border transactions, and the feedback is used to update the first machine-learning model and the second machine-learning model.

17. A non-transitory computer readable medium having stored thereon software instructions that, when executed by a processor, cause the processor to predict cardholder cross-border payment card usage, by executing the steps comprising:
identifying cardholders who have purchased an international travel reservation using a payment card by:
i) extracting travel purchase transactions from payment transaction records;
ii) retrieving travel itinerary records from one or more travel databases, at least a portion of the travel itinerary records indicating a destination for the corresponding travel itinerary;
iii) finding matches between the travel purchase transactions and the travel itinerary records, and determining for the matching travel purchase transactions, a departure country, a final destination country and a departure date, based at least in part on analyzing corresponding travel itinerary records;
iv) identifying matching ones of the travel purchase as international travel reservations based on the departure country being different from the final destination country and where the departure date occurs in the future; and
v) applying an international flight classification model to non-matching ones of the travel purchase transactions to infer whether the non-matching travel purchase transactions comprise international travel reservations based on a first set of attributes including, travel purchase amount and a purchase merchant;
for the travel purchase transactions identified as the international travel reservations by iv) and v), applying a probability model to generate a score indicating a probability of the corresponding payment card being used by the identified cardholders for a subsequent cross-border payment transactions based on a second set of attributes including transaction attributes and card-level attributes; and
profiling the payment cards having a relatively low probability to identify a set of incentives to incorporate into new offers of benefits or products made to cardholders.

18. The non-transitory computer readable medium of claim 17, further comprising:
storing a list of the payment cards having a relatively low probability and corresponding scores; and
taking the action prior to the departure date associated with the international travel reservations, the action including at least one of: forwarding at least a portion of the list of the payment cards to issuers to modify cardholder behavior, or directly offering the cardholders customized travel related local experiences.

19. The non-transitory computer readable medium of claim 17, further comprising:
determining the final destination country by:
responsive to determining that travel leg(s) associated with a same payment card are non-stop or one-way with no stops, inferring a destination of the non-stop or the one-way travel leg is the final destination of the international travel reservation; and
responsive to determining that travel leg(s) associated with the same payment card define a multiple travel-leg pattern, determining whether the multiple travel-leg pattern comprises a one-direction leg pattern or a symmetrical leg pattern;
for the one-direction leg pattern, inferring the destination of a last travel leg in the one-direction leg pattern is the final destination;
for the symmetrical leg pattern, analyzing the symmetry of the multiple travel-leg pattern and inferring that the destination of the travel-leg in a middle of the multiple travel-leg pattern is the final destination; and
determining the final destination country from the final destination.

20. The non-transitory computer readable medium of claim 17, wherein the transaction attributes comprise the travel purchase amount and the final destination country; and card-level attributes comprise card portfolio data, spend behavior data, and cross-border travel behavior data.
